(19) United States
(12) Patent Application Publication
(10) Pub. No.: US 2025/0194599 A1
(43) Pub. Date: Jun. 19, 2025

(54) PESTICIDE FORMULATIONS

(71) Applicants: FMC CORPORATION, Philadelphia, PA (US); FMC IP TECHNOLOGY GMBH, Neuhausen (CH)

(72) Inventors: Robert ALBER, Geneva (CH); Paul DUNN, Singapore (SG); Carlos Horacio FERNANDEZ BESCHTEDT, Buenos Aires (AR); Jorge Luis MORRE, Buenos Aires (AR); Santiago Alejandro SCARPONI, Buenos Aires (AR); Luis TEXEIRA, Haddonfield, NJ (US)

(21) Appl. No.: 18/844,774

(22) PCT Filed: Mar. 3, 2023
(86) PCT No.: PCT/US2023/014541

§ 371 Date: Sep. 6, 2024

Related U.S. Application Data
(60) Provisional application No. 63/317,570, filed on Mar. 8, 2022.

(51) Int. Cl. A01N 43/56; A01N 31/02; A01N 37/06; A01P 7/04; A01P 19/00

(52) U.S. Cl. CPC A01N 43/56; A01N 31/02; A01N 37/06; A01P 7/04; A01P 19/00

(57) ABSTRACT

The present application provides pesticide compositions useful for controlling a population of lepidoptera (e.g., Cydia pomonella) and reducing crop damage. Processes of preparing the compositions, methods of using the compositions, and devices comprising the compositions are also provided.

### CROSS-REFERENCE TO RELATED APPLICATION

This application claims the benefit of U.S. Provisional Application No. 63/317,570 filed Mar. 8, 2022.

### TECHNICAL FIELD

This invention relates to pesticide formulations, for example, compositions useful for controlling a population of Cydia pomonella.

### BACKGROUND

Semiochemicals, marker or signal chemicals transmitting information between individuals of the same species (pheromone) or different species (allelochemicals), have been used in various biological pest control methods. These natural substances are useful due to high selectivity and a reduced likelihood for pests to develop a resistance compared to synthetic organic insecticides.

### SUMMARY

The present application provides, inter alia, a composition comprising a semiochemical component selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components, chlorantraniliprole, and one or more carriers.

The present application further provides a process of preparing a composition provided herein, comprising admixing a first composition comprising the semiochemical component and one or more carriers, and a second composition comprising chlorantraniliprole and one or more carriers, thereby preparing the composition.

The present application further provides a method of controlling a population of Cydia pomonella, comprising applying a composition provided herein to an area in an amount effective to attract the Cydia pomonella.

The present application further provides a method of controlling a population of Cydia pomonella, comprising applying a composition provided herein to an area that has been identified as being populated or having been populated with the Cydia pomonella in an amount effective to attract the Cydia pomonella.

The present application further provides a method of reducing crop damage, comprising applying the composition provided herein to an area where the fruit or crop is grown.

The present application further provides a method of controlling a population of Cydia pomonella, comprising:
(i) applying a semiochemical composition comprising a semiochemical component selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the foregoing semiochemical components and one or more carriers, to an area in an amount effective to attract the Cydia pomonella; and
(ii) applying a pesticide composition comprising chlorantraniliprole and one or more carriers to the area.

The present application further provides a method of controlling a population of Cydia pomonella in an area has been identified as being populated or having been populated with the Cydia pomonella.

The present application further provides a composition that may be dispensed by any number of mechanisms and in different formulations appropriate to particular types of usage. The function of the different formulations and mechanisms is to provide release of the composition over a period of time sufficient to attract codling moth, effectively to an available source of a control agent which is effective against codling moth.

The present application further provides mechanisms or devices used to release the compositions of the present disclosure, such as timed release dispensers or spray cans.

Combining a semiochemical component selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components, chlorantraniliprole, and one or more carriers as disclosed herein, provide a means of local extermination, not requiring wide-disbursement of the insecticide. Addition of a slow release chemical mechanism, such as suitable microencapsulation techniques and controlled release devices provide a means to deliver the composition disclosed herein in a safe manner. In one embodiment, a slow release chemical mechanism provide a means to deliver the composition disclosed herein in a timed manner. Combining a semiochemical component selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components, chlorantraniliprole, and one or more carriers as disclosed herein and adding a slow release mechanism also provides a means of extermination requiring fewer insecticide applications.

The present application further provides a spray composition comprising the compositions disclosed herein. In some embodiments the spray composition further comprises a propellant.

The present application further provides a device comprising a composition described herein.

The present application further provides a device comprising a composition which is prepared according to one or more of the processes described herein. In some embodiments, the device is a sprayer. In some embodiments, the device is selected from a centrifugal sprayer, handheld sprayer, backpack sprayer, boom sprayer, and ground sprayer. In some embodiments, the device is a dispenser. In some embodiments, the dispenser allows a slow release of the compositions described herein. In some embodiments, the dispenser allows release of the compositions disclosed herein in a timed manner.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### DESCRIPTION OF DRAWINGS

FIGS. 1A-1C show aerial images of the farms and land tracts evaluated in the field trials described in Example 1. Plot sizes: Farm 1 (FIG. 1A), Treatment 1=1 ha; Farm 1, Treatment 2=1.17 ha; Farm 1, Treatment 3=1.1 ha; Farm 2, Treatment 1=1.1 ha; Farm 2 (FIG. 1B), Treatment 2=1.1 ha; Farm 2, Treatment 3=1.1 ha; Farm 3 (FIG. 1C), Treatment 1=1.08 ha; Farm 3, Treatment 2=1.53 ha; and Farm 3, Treatment 3=1.28 ha.

FIG. 2 shows fruit damage evaluated from the field trials described in Example 1. Left bars=chlorantraniliprole (20 mL/ha); Middle Bars=chlorantraniliprole (20 mL/ha)+(E,E)-8,10-dodecadien-1-ol (200 mL/ha); Right Bars=Grower Standard Treatments (90 dispensers/ha).

FIG. 3 shows pupae counts evaluated from the field trials described in Example 1. Left bar=chlorantraniliprole (20 mL/ha); Middle Bar=chlorantraniliprole (20 mL/ha)+(E,E)-8,10-dodecadien-1-ol (200 mL/ha); Right Bar=Grower Standard Treatments (90 dispensers/ha).

FIG. 4 shows the number of damaged fruits out of 1000 fruits per treatment from the field trials described in Example 2. Levels not connected by same letter (a, b, c) are significantly different (Tukey's HSD 0.05).

FIG. 5 shows the percent damaged fruits out of 1000 fruits per treatment from the field trials described in Example 2. Levels not connected by same letter (a, b, c) are significantly different (Tukey's HSD 0.05).

FIG. 6 shows the number of larva per hectare captured from corrugated cardboard traps settled in 100 trees from the field trials described in Example 2. Levels not connected by same letter (a, b, c) are significantly different (Student's T 0.05).

### DETAILED DESCRIPTION

The present application relates to compositions comprising a semiochemical component selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components, chlorantraniliprole, and one or more carriers, which are useful for controlling population of the codling moth (Cydia pomonella), a major pest of apples and pears by means of aggregating, attracting, and killing the adult moths and larvae responsible for crop damage, and/or by means of mating disruption. Semiochemicals selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components are useful in various insect control methods include, for example, in “bait” in traps used to attract and catch male insects (pheromones, such as (E,E)-8,10-dodecadien-1-ol, (E,E)-8,10-dodecadienyl acetate, or (E,E)-8,10-dodecadienal) or attract and catch female and male insects (kairomones, such as ethyl (2E,4Z)-2,4-decadienoate). Alternatively, semiochemicals selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components can be dispersed from one or more sources to confuse male insects and hinder attempts to locate females, thereby disrupting mating.

### Compositions & Processes

Accordingly, the present application provides a composition comprising a semiochemical component selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components, chlorantraniliprole, and one or more carriers.

In some embodiments, the composition comprises (E,E)-8,10-dodecadien-1-ol, chlorantraniliprole, and one or more carriers.

In some embodiments, the composition comprises ethyl (2E,4Z)-2,4-decadienoate, chlorantraniliprole, and one or more carriers.

In some embodiments, the semiochemical component comprises one or more agents suitable for attracting a species of Lepidoptera.

In some embodiments, the species of Lepidoptera is selected from Alabama argillacea, Anticarsia gemmatalis, Archips argyrospila, A. rosana, Chilo suppressalis, Chrysodeixis inludens, Cnaphalocrosis medinalis Guenèe, Crambus caliginosellus, Crambus teterrellus, Cydia pomonella, Diatraea saccharalis, Earias insulana, Earias vittella, Eupecilia ambiguella, Helicoverpa armigera, Helicoverpa zea Boddie, Heliothis virescens, Herpetogramma licarsisalis, Lobesia botrana, Ostrinia nubilalis, Pectinophora gossypiella, Phyllocnistis citrella, Pieris brassicae Linnaeus, Pieris rapae, Plutella xylostella, Scirpophaga incertulas, Sesamia inferens, Spodoptera cosmioides, Spodoptera eridania, Spodoptera exigua, Spodoptera littoralis, Spodoptera litura, Spodoptera frugiperda, Trichoplusia ni, and Tuta absoluta.

In some embodiments, the semiochemical component comprises one or more agents suitable for attracting Cydia pomonella.

In some embodiments, the semiochemical component comprises (E,E)-8,10-dodecadien-1-ol, (E,E)-8,10-dodecadienyl acetate, (E,E)-8,10-dodecadienal, or ethyl (2E,4Z)-2,4-decadienoate. In some embodiments, (E,E)-8,10-dodecadien-1-ol, (E,E)-8,10-dodecadienyl acetate, (E,E)-8,10-dodecadienal, or ethyl (2E,4Z)-2,4-decadienoate is suitable for attracting Cydia pomonella.

In some embodiments, the semiochemical component comprises (E,E)-8,10-dodecadien-1-ol, (E,E)-8,10-dodecadienyl acetate, (E,E)-8,10-dodecadienal, ethyl (2E,4Z)-2,4-decadienoate, or any combination thereof.

In some embodiments, the (E,E)-8,10-dodecadien-1-ol, (E,E)-8,10-dodecadienyl acetate, (E,E)-8,10-dodecadienal, or a combination of the foregoing is suitable for attracting Cydia pomonella.

In some embodiments, the (E,E)-8,10-dodecadien-1-ol is suitable for attracting Cydia pomonella.

In some embodiments, ethyl (2E,4Z)-2,4-decadienoate is suitable for attracting Cydia pomonella.

In some embodiments, the composition comprises about 20% by weight to about 60% by weight of a semiochemical component selected from (E,E)-8,10-dodecadien-1-ol, (E,E)-8,10-dodecadienyl acetate, and (E,E)-8,10-dodecadienal, or a combination of the foregoing compared to the total amount of the semiochemicals component selected from (E,E)-8,10-dodecadien-1-ol, (E,E)-8,10-dodecadienyl acetate, and (E,E)-8,10-dodecadienal, or a combination of the foregoing, respectively and chlorantraniliprole in the composition, for example, about 20%, about 25%, about 30%, about 35%, about 40%, about 45%, about 50%, about 55%, or about 60% by weight of (E,E)-8,10-dodecadien-1-ol, (E,E)-8,10-dodecadienyl acetate, or (E,E)-8,10-dodecadienal, or a combination of the foregoing compared to the total amount of (E,E)-8,10-dodecadien-1-ol, (E,E)-8,10-dodecadien-1-ol, (E,E)-8,10-dodecadienyl acetate, or (E,E)-8,10-dodecadienal, or a combination of the foregoing, respectively, and chlorantraniliprole in the composition.

In some embodiments, the semiochemical component is (E,E)-8,10-dodecadien-1-ol. In some embodiments, the semiochemical component is (E,E)-8,10-dodecadienyl acetate. In some embodiments, the semiochemical component is (E,E)-8,10-dodecadienal.

In some embodiments, the composition comprises about 35% by weight to about 45% by weight of (E,E)-8,10-dodecadien-1-ol, (E,E)-8,10-dodecadienyl acetate, or (E,E)-8,10-dodecadienal, or a combination of the foregoing compared to the total amount of (E,E)-8,10-dodecadien-1-ol, (E,E)-8,10-dodecadienyl acetate, or (E,E)-8,10-dodecadienal, or a combination of the foregoing, respectively, and chlorantraniliprole in the composition. In some embodiments, the composition comprises (E,E)-8,10-dodecadien-1-ol. In some embodiments, the composition comprises (E,E)-8,10-dodecadienyl acetate. In some embodiments, the composition comprises is (E,E)-8,10-dodecadienal.

In some embodiments, the composition comprises about 40% by weight to about 45% by weight of (E,E)-8,10-dodecadien-1-ol, (E,E)-8,10-dodecadienyl acetate, or (E,E)-8,10-dodecadienal, or a combination of the foregoing compared to the total amount of (E,E)-8,10-dodecadien-1-ol, (E,E)-8,10-dodecadienyl acetate, or (E,E)-8,10-dodecadienal, or a combination of the foregoing, respectively, and chlorantraniliprole in the composition. In some embodiments, the composition comprises (E,E)-8,10-dodecadien-1-ol. In some embodiments, the composition comprises (E,E)-8,10-dodecadienyl acetate. In some embodiments, the composition comprises is (E,E)-8,10-dodecadienal.

In some embodiments, the semiochemical component comprises ethyl (2E,4Z)-2,4-decadienoate.

In some embodiments, ethyl (2E,4Z)-2,4-decadienoate is a kairomone.

In some embodiments, the ethyl (2E,4Z)-2,4-decadienoate is suitable for attracting Cydia pomonella.

In some embodiments, the composition comprises about 1% by weight to about 15% by weight of ethyl (2E,4Z)-2,4-decadienoate compared to the total amount of ethyl (2E,4Z)-2,4-decadienoate and chlorantraniliprole in the composition, for example, about 1%, about 2%, about 3%, about 4%, about 5%, about 6%, about 7%, about 8%, about 9%, about 10%, about 11%, about 12%, about 13%, about 14%, or about 15% by weight of ethyl (2E,4Z)-2,4-decadienoate compared to the total amount of ethyl (2E,4Z)-2,4-decadienoate and chlorantraniliprole in the composition.

In some embodiments, the composition comprises about 1% by weight to about 10% by weight of ethyl (2E,4Z)-2,4-decadienoate compared to the total amount of ethyl (2E,4Z)-2,4-decadienoate and chlorantraniliprole in the composition.

In some embodiments, the composition comprises about 5% by weight to about 10% by weight of ethyl (2E,4Z)-2,4-decadienoate compared to the total amount of ethyl (2E,4Z)-2,4-decadienoate and chlorantraniliprole in the composition.

In some embodiments, the pesticide component is suitable for controlling a population of a species of lepidoptera.

In some embodiments, the species of Lepidoptera is selected from Alabama argillacea, Anticarsia gemmatalis, Archips argyrospila, A. rosana, Chilo suppressalis, Chrysodeixis inludens, Cnaphalocrosis medinalis Guenèe, Crambus caliginosellus, Crambus teterrellus, Cydia pomonella, Diatraea saccharalis, Earias insulana, Earias vittella, Eupecilia ambiguella, Helicoverpa armigera, Helicoverpa zea Boddie, Heliothis virescens, Herpetogramma licarsisalis, Lobesia botrana, Ostrinia nubilalis, Pectinophora gossypiella, Phyllocnistis citrella, Pieris brassicae Linnaeus, Pieris rapae, Plutella xylostella, Scirpophaga incertulas, Sesamia inferens, Spodoptera cosmioides, Spodoptera eridania, Spodoptera exigua, Spodoptera littoralis, Spodoptera litura, Spodoptera frugiperda, Trichoplusia ni, and Tuta absoluta. In some embodiments, the pesticide component is suitable for controlling a population of Cydia pomonella.

In some embodiments, the pesticide component is chlorantraniliprole. As used herein, the terms “chlorantraniliprole” and “Rynaxypyr®” refer to 3-bromo-N-(4-chloro-2-methyl-6-(methylcarbamoyl)phenyl)-1-(3-chloropyridin-2-yl)-1H-pyrazole-5-carboxamide (structure shown below).

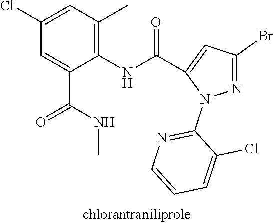 [SMILES: CNC(=O)c1cc(Cl)cc(C)c1NC(=O)c1cc(Br)nn1-c1ncccc1Cl]

In some embodiments, the composition comprises about 40% by weight to about 99% by weight of chlorantraniliprole compared to the total amount of semiochemical component as described herein and chlorantraniliprole in the composition, for example, about 40%, about 45%, about 50%, about 55%, about 60%, about 65%, about 70%, about 75%, about 80%, about 85%, about 90%, about 91%, about 92%, about 93%, about 94%, about 95%, about 96%, about 97%, about 98%, or about 99% by weight of chlorantraniliprole compared to the total amount of semiochemical component as described herein and chlorantraniliprole in the composition.

In some embodiments, the composition comprises about 40% by weight to about 80% by weight of chlorantraniliprole compared to the total amount of (E,E)-8,10-dodecadien-1-ol, (E,E)-8,10-dodecadienyl acetate, or (E,E)-8,10-dodecadienal, or a combination of the foregoing and chlorantraniliprole in the composition.

In some embodiments, the composition comprises about 40% by weight to about 80% by weight of chlorantraniliprole compared to the total amount of (E,E)-8,10-dodecadien-1-ol and chlorantraniliprole in the composition.

In some embodiments, the composition comprises about 55% by weight to about 65% by weight of chlorantraniliprole compared to the total amount of (E,E)-8,10-dodecadien-1-ol, (E,E)-8,10-dodecadienyl acetate, or (E,E)-8,10-dodecadienal, or a combination of the foregoing and chlorantraniliprole in the composition.

In some embodiments, the composition comprises about 55% by weight to about 65% by weight of chlorantraniliprole compared to the total amount of (E,E)-8,10-dodecadien-1-ol and chlorantraniliprole in the composition.

In some embodiments, the composition comprises about 55% by weight to about 60% by weight of chlorantraniliprole compared to the total amount of (E,E)-8,10-dodecadien-1-ol, (E,E)-8,10-dodecadienyl acetate, or (E,E)-8,10-dodecadienal, or a combination of the foregoing and chlorantraniliprole in the composition.

In some embodiments, the composition comprises about 55% by weight to about 60% by weight of chlorantraniliprole compared to the total amount of (E,E)-8,10-dodecadien-1-ol and chlorantraniliprole in the composition.

In some embodiments, the composition comprises about 20% by weight to about 60% by weight of (E,E)-8,10-dodecadien-1-ol, (E,E)-8,10-dodecadienyl acetate, or (E,E)-8,10-dodecadienal, or a combination of the foregoing and about 40% by weight to about 80% by weight of chlorantraniliprole compared to the total amount of (E,E)-8,10-dodecadien-1-ol, (E,E)-8,10-dodecadienyl acetate, or (E,E)-8,10-dodecadienal, or a combination of the foregoing, respectively and chlorantraniliprole in the composition.

In some embodiments, the composition comprises about 20% by weight to about 60% by weight of (E,E)-8,10-dodecadien-1-ol and about 40% by weight to about 80% by weight of chlorantraniliprole compared to the total amount of (E,E)-8,10-dodecadien-1-ol and chlorantraniliprole in the composition.

In some embodiments, the composition comprises about 35% by weight to about 45% by weight of (E,E)-8,10-dodecadien-1-ol, (E,E)-8,10-dodecadienyl acetate, or (E,E)-8,10-dodecadienal, or a combination of the foregoing and about 55% by weight to about 65% by weight of chlorantraniliprole compared to the total amount of (E,E)-8,10-dodecadien-1-ol, (E,E)-8,10-dodecadienyl acetate, or (E,E)-8,10-dodecadienal, or a combination of the foregoing, respectively and chlorantraniliprole in the composition.

In some embodiments, the composition comprises about 35% by weight to about 45% by weight of (E,E)-8,10-dodecadien-1-ol and about 55% by weight to about 65% by weight of chlorantraniliprole compared to the total amount of (E,E)-8,10-dodecadien-1-ol and chlorantraniliprole in the composition.

In some embodiments, the composition comprises about 40% by weight to about 45% by weight of (E,E)-8,10-dodecadien-1-ol, (E,E)-8,10-dodecadienyl acetate, or (E,E)-8,10-dodecadienal, or a combination of the foregoing and about 55% by weight to about 60% by weight of chlorantraniliprole compared to the total amount of (E,E)-8,10-dodecadien-1-ol, (E,E)-8,10-dodecadienyl acetate, or (E,E)-8,10-dodecadienal, or a combination of the foregoing, respectively, and chlorantraniliprole in the composition.

In some embodiments, the composition comprises about 40% by weight to about 45% by weight of (E,E)-8,10-dodecadien-1-ol and about 55% by weight to about 60% by weight of chlorantraniliprole compared to the total amount of (E,E)-8,10-dodecadien-1-ol and chlorantraniliprole in the composition.

In some embodiments, the composition comprises about 85% by weight to about 99% by weight of chlorantraniliprole compared to the total amount of ethyl (2E,4Z)-2,4-decadienoate, and chlorantraniliprole in the composition.

In some embodiments, the composition comprises about 90% by weight to about 99% by weight of chlorantraniliprole compared to the total amount of ethyl (2E,4Z)-2,4-decadienoate and chlorantraniliprole in the composition.

In some embodiments, the composition comprises about 90% by weight to about 95% by weight of chlorantraniliprole compared to the total amount of ethyl (2E,4Z)-2,4-decadienoate and chlorantraniliprole in the composition.

In some embodiments, the composition comprises about 1% by weight to about 15% by weight of ethyl (2E,4Z)-2,4-decadienoate and about 85% by weight to about 99% by weight of chlorantraniliprole compared to the total amount of ethyl (2E,4Z)-2,4-decadienoate and chlorantraniliprole in the composition.

In some embodiments, the composition comprises about 1% by weight to about 10% by weight of ethyl (2E,4Z)-2,4-decadienoate and about 90% by weight to about 99% by weight of chlorantraniliprole compared to the total amount of ethyl (2E,4Z)-2,4-decadienoate and chlorantraniliprole in the composition.

In some embodiments, the composition comprises about 5% by weight to about 10% by weight of ethyl (2E,4Z)-2,4-decadienoate and about 90% by weight to about 95% by weight of chlorantraniliprole compared to the total amount of ethyl (2E,4Z)-2,4-decadienoate and chlorantraniliprole in the composition.

In some embodiments, the composition comprises one or more carriers selected from water, oil, emulsifiers, UV absorbers, UV blocking agents, surfactants, antioxidants, viscosity regulating agents, inert solvents, dispersants, buffers, diluents, and polymers, or any combination thereof. Examples of suitable carriers can be found, for example, in U.S. Publication No. 2019/0082685, U.S. Pat. Nos. 6,528,049, and International Application No. PCT/US2020/065528.

In some embodiments, the carrier comprises an inert solvent. In some embodiments, the inert solvent is an inert organic solvent. Example solvents include, but are not limited to, glycols, such as propylene glycol and polyethylene glycols of different molecular weight; ketones, such as methyl isobutyl ketone, methyl isopropyl ketone and cyclohexanone; amides, such as dimethylformamide or diethyl formamide; N, N-dialkylated carboxamides; alkyl lactams, such as substituted pyrrolidones and caprolactams hydrocarbons; n-paraffins and isoparaffins; aromatic hydrocarbons, such as xylene and aromatic distillation fractions; esters, such as propylene glycol monomethyl ether acetate, dibutyl adipate and di-n-butyl phthalate; ethers, such as propylene glycol methyl ether or propylene glycol butyl ether; alcohols, such as ethanol, n- and ipropanol, n- and i-butanol, n- and i-amyl alcohol, benzyl alcohol, tetrahydrofurfuryl alcohol, 1-methoxy-2-propanol and higher alcohols; dimethyl sulphoxide; dioxane; and tetrahydrofuran. The solvents can be employed in the form of individual components or mixtures. In some embodiments, the solvent is not unduly volatile and may be miscible with one or more additional carriers described herein (e.g., miscible with a UV absorber or blocker as described herein).

In some embodiments, the carrier comprises water. In some embodiments, the carrier is substantially free of water.

In some embodiments, the carrier comprises a UV absorber. Example UV absorbers include, but are not limited to, 2H-benzotriazoles, 2-hydroxy-alkoxybenzophenones, oxalanilides, cinnamic acid and derivatives thereof, triazines and derivatives thereof, and the like.

In some embodiments, the carrier comprises a UV blocking agent. Example UV blocking agents include, but are not limited to, carbon black, iron oxide, titanium dioxide, zinc oxide, calcium carbonate, talc, and dyes such as Sudan block, chromophthalic blue, Terasil blue, and Cibacet yellow.

In some embodiments, the carrier comprises an antioxidant. Example antioxidants include, but are not limited to, sterically hindered phenols and alkyl-substituted hydroxyanisoles and hydroxytoluenes, PERMALUX®, NEOZONE® A or D, TOPANOL CA®, N,N′-diphenyl-1,4-phenylenediamine and other substituted phenylenediamines.

In some embodiments, the carrier comprises a viscosity regulating agent, buffer, or any combination thereof. Examples of viscosity regulating agents and buffers suitable for formulating insecticide compositions, as described herein, would be readily understood by the skilled artisan.

In some embodiments, the carrier comprises oil. Example oils include, but are not limited to, vegetable oils, ethoxylated soybean oils, castor oils, and rapeseed oils.

In some embodiments, the carrier comprises an emulsifier, including non-ionic and anionic emulsifiers. Example emulsifiers include, but are not limited to, polyoxyethylene fatty acid esters, polyoxyethylene fatty alcohol ethers and alkylaryl surfactants. Other suitable emulsifiers are known in the art and can be found, for example, in McCutcheon's “Emulsifiers and Detergents” (1982), North America Edit., MC Publishing co., 30 Glen Rock, N.J.

In some embodiments, the carrier comprises a diluent. Non-limiting examples of suitable diluents include, but are not limited to, water, N,N-dimethylalkanamides (e.g., N,N dimethylformamide), limonene, dimethyl sulfoxide, N-alkylpyrrolidones (e.g., N-methylpyrrolidinone), alkyl phosphates (e.g., triethylphosphate), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone, and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters alkyl and aryl benzoates, γ-butyrolactone, and alcohols, which can be linear, branched, saturated or unsaturated, such as methanol, ethanol, n-propanol, i-propanol, n-butanol, i-butanol, n-hexanol, 2-ethylhexanol, n-octanol, decanol, i-decyl alcohol, i-octadecanol, cetyl alcohol, lauryl alcohol, tridecyl alcohol, oleyl alcohol, cyclohexanol, tetrahydrofurfuryl alcohol, diacetone alcohol, cresol, benzyl alcohol, and combinations thereof. Diluents also include glycerol esters of saturated and unsaturated fatty acids (typically C₆₋₂₂ fatty acids), such as plant seed and fruit oils e.g., oils of olive, castor, linseed, sesame, corn (maize), peanut, sunflower, grapeseed, safflower, cottonseed, soybean, rapeseed (canola) (e.g., Codacide® Oil containing rapeseed oil and emulsifiers), coconut and palm kernel oils, animal-sourced fats (e.g., beef tallow, pork tallow, lard, cod liver oil, fish oil), and mixtures thereof. Diluents also include alkylated fatty acids (e.g., methylated, ethylated, butylated) wherein the fatty acids may be obtained by hydrolysis of glycerol esters from plant and animal sources, and can be purified by distillation.

In some embodiments, the carrier comprises a polymer (e.g., a polymeric surfactant).

In some embodiments, the carrier comprises a surfactant. In some embodiments, the surfactant is a gemini surfactant. As used herein, the term “gemini surfactant” refers to surfactants having more than one hydrophilic head group and hydrophobic tail group linked by a spacer at or near the head groups. A non-limiting example of a gemini surfactant includes Surfynol 104 PG 50. In some embodiments, the gemini surfactant comprises at least two polar groups selected from alcohols, halogens, amines, phosphates, sulfates, sulfonates, and carboxylates.

In some embodiments, the carrier comprises a dispersant. As used here, the term “dispersant” refers to an agent capable of dispersing active ingredients in the composition (i.e., the semiochemical component and pesticide component) and prevent agglomeration after dispersal in water.

In some embodiments, the dispersant comprises at least one polymeric surfactant. Polymeric surfactants fall into several categories including, but not limited to, block copolymers, random copolymers, graft copolymer, and star polymers. Polymeric surfactants can be nonionic or anionic. Examples of block copolymers include, but are not limited to, Atlas™ G-5000 and Atlas™ G-5002L (butyl block copolymers). A non-limiting example of a graft copolymer is Atlox® 4913 (a methyl methacrylate graft copolymer backbone having PEG extending therefrom). A non-limiting example of a nonionic polymer is Break Thru® DA 647. A non-limiting example of an anionic polymer is modified styrene acrylic polymer (e.g., Metasperse™ 550s) or salts of lignonsulfonates (e.g. Reax 88B or Borresperse NA).

In some embodiments, the dispersant is selected from sulfonated aromatic polymer sodium salts, alkyl naphthalene sulfonate condensate sodium salts, alkyl naphthalene sulfonates, alkyl naphthalene sulfonate salts, naphthalene sulfonate salts, naphthalene sulfonate condensates, naphthalene sulfonate-formaldehyde condensates, naphthalenesulfonic acid polymers with formaldehyde and sodium, naphthalene sulfonate condensate sodium salts, alkyl naphthalene sulfonate-formaldehyde condensates, alkyl naphthalene sulfonate-formaldehyde condensate salts, and combinations thereof.

In some embodiments, the dispersant is selected from sulfonated aromatic polymer sodium salts, alkyl naphthalene sulfonate condensate sodium salts, naphthalene sulfonate condensates, naphthalene sulfonate-formaldehyde condensates, naphthalenesulfonic acid polymers with formaldehyde and sodium, naphthalene sulfonate condensate sodium salts, alkyl naphthalene sulfonate-formaldehyde condensate salts, and combinations thereof.

In some embodiments, the dispersant is selected from sodium lignosulfonate, calcium lignosulfonate, lignosulfonic acid sodium salt, lignosulfonic acid, and combinations thereof.

In some embodiments, the dispersant is selected from Atlox 4913, Atlas™ G-5000, Morwet D425, and combinations thereof.

In some embodiments, the dispersant is selected from an anionic dispersants. In some embodiments, the anionic dispersant is selected form, but not limited to alkyl naphthalene sulfonate condensates (e.g. Morwet D-400 and Morwet D-809), lignin sulfonates (e.g. Reax 88B and Polyfon F), blends of lignin and naphthalene sulfonates (e.g. Morwet D-360 and Morwet D-390), Morwet D-500 (blend of Morwet D-425 and block copolymer), phenol sulfonate condensates (e.g. Vultamol®DN), polyacrylates (e.g. Agrilan 789 and Agrilan 700), polyacrylate graft copolymers (e.g. Dispersogen ACP 120), sodium salt of fatty acid methyl tauride (e.g. Hostapon TPHC), sodium salt of a cresol-formaldehyde condensation product (e.g. Dispersogen 1494), styrene acrylic copolymers (e.g. Metasperse 550S), alkoxylate fatty alcohol phosphate esters (e.g. Crodafos C10/5A and Dextrol OC-180), aryl phenol ethoxylate phosphate esters (e.g. Soprophor FLK), aryl phenol ethoxylate sulfate esters (e.g. Soprophor 4D384), maleic acid/acrylic acid copolumers (e.g. Sokalan® CP 5 and Sokalan® CP 7), maleic acid/olefin copolymer (e.g. Sokalan® CP 9), alkyl diphenyloxide sulfonates (e.g. Dowfax 3B2 and Dowfax C10L) and salts of vinyl ether polymers and copolymers (e.g. EasySperse™ P-20).

In some embodiments, the dispersant is selected from naphthalene sulfonate derivatives, and lignosulfonate derivatives, or any combination thereof.

In some embodiments, the naphthalene sulfonate derivative is selected from sulfonated aromatic polymer sodium salts, alkyl naphthalene sulfonate condensate sodium salts, alkyl naphthalene sulfonates, alkyl naphthalene sulfonate salts, naphthalene sulfonate salts, naphthalene sulfonate condensates, naphthalene sulfonate-formaldehyde condensates, naphthalenesulfonic acid polymers with formaldehyde and sodium, naphthalene sulfonate condensate sodium salts, alkyl naphthalene sulfonate-formaldehyde condensates, and alkyl naphthalene sulfonate-formaldehyde condensate salts, or any combination thereof.

In some embodiments, the naphthalene sulfonate derivative is a sodium alkyl naphthalene sulfonate-formaldehyde condensate.

In some embodiments, the lignosulfonate derivative is selected from sodium lignosulfonate, calcium lignosulfonate, lignosulfonic acid sodium salt, and lignosulfonic acid, or any combination thereof.

In some embodiments, the composition provided herein is a suspension concentrate. As used herein, suspension concentrates (SC; or suspension concentration formulations) comprise solid active ingredients dispersed in water. SCs are particularly useful due to ease of use and effectiveness, elimination of dust, and elimination of solvent hazards, e.g., when compared to emulsifiable concentrate (EC) and wettable powder (WP) formulations. Methods of preparing suspension concentrates are known in the art and are described, for example, in International Application No.: PCT/US2020/065528.

In some embodiments, the composition provided herein is a capsule suspension.

In some embodiments, the composition provided herein is the composition is a mixture of a suspension concentrate and a capsule suspension. As used herein, a capsule suspension (CS) refers to a composition containing a combination of an active ingredient encapsulated in polymer shell suspended in water with a dispersant and wetting agent. In some embodiments, the wetting agent is a gemini surfactant as described herein. In some embodiments, the wetting agent is a gemini surfactant comprising at least two polar groups selected from alcohols, halogens, amines, phosphates, sulfates, sulfonates, and carboxylates. In some embodiments, the wetting agent is a gemini surfactant comprising at least two hydrophobic chains selected from branched or unbranched C₁-C₁₂ alkyl, branched or unbranched C₁-C₁₂ alkenyl, and branched or unbranched C₁-C₁₂ alkynyl. In some embodiments, the wetting agent is a gemini surfactant comprising a spacer selected from C₁-C₁₂ alkyl, C₁-C₁₂ alkenyl, and C₁-C₁₂ alkynyl. In some embodiments, the wetting agent is 2,4,7,9-tetramethyldec-5-yne-4,7-diol (Surfynol 104). In some embodiments, the wetting agent is 2,5,8,11-tetramethyl-6-dodecyn-5,8-diol ethoxylate (Dynol 607).

In some embodiments, the composition provided herein is a homogenous mixture. In some embodiments, the composition provided herein is a sprayable composition.

### Processes of Preparing Compositions

The present application further provides a process of preparing the composition of provided herein (e.g., a composition comprising a semiochemical component selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components, chlorantraniliprole, and one or more carriers).

In some embodiments, the process comprises comprising admixing a first composition comprising the semiochemical component, a second composition comprising chlorantraniliprole, and one or more additional compositions comprising the one or more carriers, thereby preparing the composition.

In some embodiments, the first composition is a premix comprising the semiochemical component and one or more carriers.

In some embodiments, the second composition is a premix comprising chlorantraniliprole and one or more carriers.

In some embodiments, the process comprises comprising admixing a first composition comprising the semiochemical component and one or more carriers, and a second composition comprising chlorantraniliprole and one or more carriers, thereby preparing the composition.

In some embodiments, the first composition comprises about 1 w/v % to about 20 w/v % of the semiochemical component, for example, about 1 w/v %, about 5 w/v %, 10 w/v %, about 11 w/v %, about 12 w/v %, about 13 w/v %, about 14 w/v %, about 15 w/v %, about 16 w/v %, about 17 w/v %, about 18 w/v %, about 19 w/v %, or about 20 w/v %.

In some embodiments, the first composition comprises about 13 w/v % to about 15 w/v % of the semiochemical component.

In some embodiments, the first composition comprises about 13 w/v % to about 15 w/v % of pheromone.

In some embodiments, the first composition comprises about 14 w/v % of pheromone, selected from (E,E)-8,10-dodecadien-1-ol, (E,E)-8,10-dodecadienyl acetate, (E,E)-8,10-dodecadienal, and any combination of the forgoing.

In some embodiments, the first composition comprises about 14 w/v % of (E,E)-8,10-dodecadien-1-ol.

In some embodiments, the first composition comprises about 13 w/v % to about 15 w/v % (E,E)-8,10-dodecadien-1-ol, (E,E)-8,10-dodecadienyl acetate, or (E,E)-8,10-dodecadienal, or any combination of the forgoing.

In some embodiments, the first composition comprises about 13 w/v % to about 15 w/v % (E,E)-8,10-dodecadien-1-ol.

In some embodiments, the first composition comprises about 13 w/v % to about 15 w/v % (E,E)-8,10-dodecadien-1-ol, (E,E)-8,10-dodecadienyl acetate, or (E,E)-8,10-dodecadienal, or any combination of the forgoing and one or more carriers.

In some embodiments, the first composition comprises about 13 w/v % to about 15 w/v % (E,E)-8,10-dodecadien-1-ol and one or more carriers.

In some embodiments, the first composition comprises about 14 w/v % (E,E)-8,10-dodecadien-1-ol, (E,E)-8,10-dodecadienyl acetate, or (E,E)-8,10-dodecadienal, or any combination of the forgoing.

In some embodiments, the first composition comprises about 14 w/v % (E,E)-8,10-dodecadien-1-ol.

In some embodiments, the first composition comprises about 14 w/v % (E,E)-8,10-dodecadien-1-ol, (E,E)-8,10-dodecadienyl acetate, or (E,E)-8,10-dodecadienal, or any combination of the forgoing and one or more carriers.

In some embodiments, the first composition comprises about 14 w/v % (E,E)-8,10-dodecadien-1-ol and one or more carriers.

In some embodiments, the first composition comprises about 14 w/v % (E,E)-8,10-dodecadien-1-ol, (E,E)-8,10-dodecadienyl acetate, or (E,E)-8,10-dodecadienal, or any combination of the forgoing and one or more carriers, and is a suspension concentrate.

In some embodiments, the first composition comprises about 14 w/v % (E,E)-8,10-dodecadien-1-ol and one or more carriers, and is a suspension concentrate.

In some embodiments, the first composition comprises (E,E)-8,10-dodecadien-1-ol sold under the tradename is Checkmate-CM-F®.

In some embodiment, the first composition comprises (E,E)-8,10-dodecadienyl acetate.

In some embodiment, the first composition comprises (E,E)-8,10-dodecadienal.

In some embodiments, the first composition comprises about 1 w/v % to about 10 w/v % of the semiochemical component.

In some embodiments, the first composition comprises about 4 w/v % to about 6 w/v % of the semiochemical component.

In some embodiments, the first composition comprises about 1 w/v % to about 10 w/v % of ethyl (2E,4Z)-2,4-decadienoate.

In some embodiments, the first composition comprises about 4 w/v % to about 6 w/v % ethyl (2E,4Z)-2,4-decadienoate.

In some embodiments, the first composition comprises about 4 w/v % to about 6 w/v % ethyl (2E,4Z)-2,4-decadienoate, and one or more carriers.

In some embodiments, the first composition comprises about 5 w/v % ethyl (2E,4Z)-2,4-decadienoate.

In some embodiments, the first composition comprises about 5 w/v % ethyl (2E,4Z)-2,4-decadienoate, and one or more carriers.

In some embodiments, the first composition comprises about 5 w/v % ethyl (2E,4Z)-2,4-decadienoate, and one or more carriers, and is a capsule suspension.

In some embodiments, the first composition comprises (2E,4Z)-2,4-decadienoate sold under the tradename Cidetrak® DA MEC.

In some embodiments, the second composition comprises about 15 w/v % to about 25 w/v % of chlorantraniliprole.

In some embodiments, the second composition comprises about 15 w/v % to about 25 w/v % of chlorantraniliprole, and one or more carriers.

In some embodiments, the second composition comprises about 17 w/v % to about 19 w/v % chlorantraniliprole.

In some embodiments, the second composition comprises about 17 w/v % to about 19 w/v % chlorantraniliprole, and one or more carriers.

In some embodiments, the second composition comprises about 18 w/v % chlorantraniliprole.

In some embodiments, the second composition comprises about 18 w/v % chlorantraniliprole, and one or more carriers.

In some embodiments, the second composition is a suspension concentrate. In some embodiments, the second composition is Coragen® 200SC.

### Methods of Use

The present application further provides a method of controlling a population of lepidoptera as described herein. In some embodiments, the method comprises applying the composition provided herein (e.g., a composition comprising a semiochemical component as described herein, chlorantraniliprole, and one or more carriers) to an area in an amount effective to attract the lepidoptera, wherein the area has been identified as being populated or having been populated with the lepidoptera.

In some embodiments, the method comprises applying the composition provided herein (e.g., a composition comprising a semiochemical component as described herein, chlorantranliprole, and one or more carriers) to an area in an amount effective to attract Cydia pomonella, wherein the area has been identified as being populated or having been populated with the Cydia pomonella. In some embodiments, the method comprises attracting male Cydia pomonella. In some embodiments, the method comprises attracting female Cydia pomonella. In some embodiments, wherein the methods provided herein further comprise disrupting mating of the Cydia pomonella.

In some embodiments, the area to be treated is an orchard (e.g., a fruit orchard, such as an apple orchard) or field (e.g., a crop field, such as a grain field). In some embodiments, the area is a pome fruit orchard, a nut orchard, or a combination thereof. In some embodiments, the area is an apple orchard, a pear orchard, a walnut orchard, a pecan orchard, or any combination thereof. In some embodiments, the area is an apple orchard.

In some embodiments, the area has been identified as being populated or having been populated with lepidoptera. In some embodiments, the composition is applied to the area in an amount effective to attract the lepidoptera.

In some embodiments, the area as being populated with Cydia pomonella. has been identified by predictive modeling based on real-time data from in-field sensors.

In some embodiments, the in-field sensors are Arc™ farm intelligence (see International Application Nos.: PCT/US21/20805 and PCT/US21/20809).

In some embodiments, the area has been identified as being populated or having been populated with Cydia pomonella. In some embodiments, the composition is applied to the area in an amount effective to attract the Cydia pomonella.

In some embodiments, the applying comprises spraying (e.g., spraying the composition onto the area to be treated).

The present application further provides a method of reducing crop damage, comprising applying a composition provided herein to an area where the fruit or crop is grown. Example crops include, but are not limited to, cereals, fruit trees, citrus fruits, legumes, horticultural crops, cucurbits, oleaginous plants, tobacco, coffee, tea, cocoa, sugar beet, sugar cane, and cotton.

In some embodiments, the crop is a pome fruit crop, a nut crop, or a combination thereof. In some embodiments, the crop is an apple crop, a pear crop, a walnut crop, a pecan crop, or any combination thereof. In some embodiments, the crop is an apple crop.

It is understood that wild plant species and plant cultivars, or those obtained by conventional biological breeding methods, such as crossing or protoplast fusion, and parts thereof, may be treated. In addition, transgenic plants and plant cultivars obtained by genetic engineering methods, if appropriate in combination with conventional methods (Genetically Modified Organisms), and parts thereof can also be treated. Plants of the plant cultivars that are in each case commercially available or in use are treated according to the disclosure. Plant cultivars are to be understood as meaning plants having novel properties (“traits”) which have been obtained by conventional breeding, by mutagenesis or by recombinant DNA techniques. These can be cultivars, biotypes, or genotypes. The transgenic plants or plant cultivars (obtained by genetic engineering) that may be treated according to the disclosure include all plants which, by the genetic modification, received genetic material which imparted particular advantageous, useful traits to these plants. Examples of such traits can be found, for example, in International Application No.: PCT/US2020/065528.

In some embodiments, the method comprises applying the composition to the area in an amount sufficient to achieve a concentration of about 25 g/ha to about 75 g/ha of the semiochemical component described herein, such as (E,E)-8,10-dodecadien-1-ol, (E,E)-8,10-dodecadienyl acetate, or (E,E)-8,10-dodecadienal, or any combination of the foregoing. In some embodiments the semiochemcial component is (E,E)-8,10-dodecadien-1-ol.

In some embodiments, the method comprises applying the composition to the area in an amount sufficient to achieve a concentration of about 25 g/ha to about 35 g/ha of the semiochemical component described herein, such as (E,E)-8,10-dodecadien-1-ol, (E,E)-8,10-dodecadienyl acetate, or (E,E)-8,10-dodecadienal, or any combination of the foregoing. In some embodiments the semiochemcial component is (E,E)-8,10-dodecadien-1-ol.

In some embodiments, the method comprises applying the composition to the area in an amount sufficient to achieve a concentration of about 30 g/ha of the semiochemical component described herein, such as (E,E)-8,10-dodecadien-1-ol, E,E)-8,10-dodecadienyl acetate, or (E,E)-8,10-dodecadienal, or any combination of the foregoing. In some embodiments the semiochemcial component is (E,E)-8,10-dodecadien-1-ol.

In some embodiments, the method comprises applying the composition to the area in an amount sufficient to achieve a concentration of about 0.5 g/ha to about 5 g/ha of the semiochemical component described herein, such as ethyl (2E,4Z)-2,4-decadienoate.

In some embodiments, the method comprises applying the composition to the area in an amount sufficient to achieve a concentration of about 0.5 g/ha to about 1.5 g/ha of the semiochemical component described herein, such as ethyl (2E,4Z)-2,4-decadienoate.

In some embodiments, the method comprises applying the composition to the area in an amount sufficient to achieve a concentration of about 1 g/ha of the semiochemical component described herein, such as ethyl (2E,4Z)-2,4-decadienoate.

In some embodiments, the method comprises applying the composition to the area in an amount sufficient to achieve a concentration of about 1 g/ha to about 10 g/ha of chlorantraniliprole.

In some embodiments, the method comprises applying the composition to the area in an amount sufficient to achieve a concentration of about 1 g/ha to about 5 g/ha of chlorantraniliprole.

In some embodiments, the method comprises applying the composition to the area in an amount sufficient to achieve a concentration of about 4 g/ha of chlorantraniliprole.

In some embodiments, the composition provided herein is applied one or more times to the area.

In some embodiments, the composition provided herein is applied one or more times to the area per season.

In some embodiments, the composition provided herein is applied one to five times to the area per season.

In some embodiments, the methods provided herein comprise a first application of the composition provided herein at about 200 DD to about 300 DD after first flight of the Cydia pomonella.

In some embodiments, the methods provided herein comprise a first application of the composition provided herein at about 240 DD to about 260 DD after first flight of the Cydia pomonella.

In some embodiments, the methods provided herein comprise a first application of the composition provided herein at about 250 DD after first flight of the Cydia pomonella.

In some embodiments, the methods provided herein further comprise a second application of the composition at about 15 DD to about 25 DD after the first application.

As used herein, the term “DD” refers to “degree days”, a measurement of heat units over time calculated from daily maximum and minimum temperatures, which are used to predict insect life cycles, and in turn, time insecticide treatments to those life cycles (see e.g., Intermountain Tree Fruit Production Guide, Utah State University, IPM Methods: Determining Treatment Timing Using Degree Days and Insect Phenology Models at https://intermountainfruit.org/ipm-methods/treatment-timing). Unless otherwise stated in this disclosure, degrees refer to degrees Celsius (° C.).

In some embodiments, the methods provided herein further comprise a second application of the composition at about 21 DD after the first application.

The present application further provides a method of controlling a population of lepidoptera, comprising:
(i) applying a semiochemical composition comprising a semiochemical component, selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components and one or more carriers, to an area in an amount effective to attract the lepidoptera; and
(ii) applying a pesticide composition comprising chlorantraniliprole and one or more carriers to the area;
wherein the area has been identified as being populated or having been populated with the lepidoptera.

The present application further provides a method of controlling a population of Cydia pomonella, comprising:
(i) applying a semiochemical composition comprising a semiochemical component, selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components and one or more carriers, to an area in an amount effective to attract the Cydia pomonella; and
(ii) applying a pesticide composition comprising chlorantraniliprole and one or more carriers to the area;
wherein the area has been identified as being populated or having been populated with the Cydia pomonella.

In some embodiments the method of controlling a population of lepidoptera, comprises:
(i) applying (E,E)-8,10-dodecadien-1-ol and one or more carriers, to an area in an amount effective to attract the lepidoptera; and
(ii) applying a pesticide composition comprising chlorantraniliprole and one or more carriers to the area;
wherein the area has been identified as being populated or having been populated with the lepidoptera.

The present application further provides a method of controlling a population of Cydia pomonella, comprising:
(i) applying a semiochemical composition comprising (E,E)-8,10-dodecadien-1-ol and one or more carriers, to an area in an amount effective to attract the Cydia pomonella; and
(ii) applying a pesticide composition comprising chlorantraniliprole and one or more carriers to the area;
wherein the area has been identified as being populated or having been populated with the Cydia pomonella.

In some embodiments the method of controlling a population of lepidoptera, comprises:
(i) applying ethyl (2E,4Z)-2,4-decadienoate and one or more carriers, to an area in an amount effective to attract the lepidoptera; and
(ii) applying a pesticide composition comprising chlorantraniliprole and one or more carriers to the area;
wherein the area has been identified as being populated or having been populated with the lepidoptera.

The present application further provides a method of controlling a population of Cydia pomonella, comprising:
(i) applying a semiochemical composition comprising ethyl (2E,4Z)-2,4-decadienoate and one or more carriers, to an area in an amount effective to attract the Cydia pomonella; and
(ii) applying a pesticide composition comprising chlorantraniliprole and one or more carriers to the area;
wherein the area has been identified as being populated or having been populated with the Cydia pomonella.

In some embodiments, step (i) is performed prior to step (ii). In some embodiments, step (ii) is performed prior to step (i). In some embodiments, step (i) and step (ii) are performed substantially simultaneously.

In some embodiments, the semiochemical composition comprising a semiochemical component selected from (E,E)-8,10-dodecadien-1-ol, (E,E)-8,10-dodecadienyl acetate, (E,E)-8,10-dodecadienal, ethyl (2E,4Z)-2,4-decadienoate, and any combination of the forgoing semiochemicals components and pesticide composition comprising chlorantraniliprole are applied separately. In some embodiments, the semiochemical component is (E,E)-8,10-dodecadien-1-ol. In some embodiments, the semiochemical component is ethyl (2E,4Z)-2,4-decadienoate. In some embodiments, the combined composition is a sprayable composition.

In some embodiments, the semiochemical composition comprising a semiochemical component selected from (E,E)-8,10-dodecadien-1-ol, (E,E)-8,10-dodecadienyl acetate, (E,E)-8,10-dodecadienal, ethyl (2E,4Z)-2,4-decadienoate, and any combination of the forgoing semiochemicals components is applied one or more times to the area. In some embodiments, the semiochemical component is (E,E)-8,10-dodecadien-1-01, In some embodiments, the semiochemical component is ethyl (2E,4Z)-2,4-decadienoate, In some embodiments, the pesticide composition comprising chlorantraniliprole is applied one or more times to the area. In some embodiments, the combined composition is applied one or more times to the area. In some embodiments, the method is performed one or more times per season. In some embodiments, the method is performed one to five times per season.

### Devices & Kits

The present application further provides kits and devices, which include one or more containers containing a composition provided herein and/or containers comprising one or more components for preparing a composition described herein. Such kits can further include one or more of various kit components, such as, e.g., containers containing the semiochemical component, containers containing the pesticide component, containers comprising the one or more carriers, and the like, as will be readily apparent to those skilled in the art. Instructions, either as inserts or as labels, indicating quantities of the components and/or amount of composition to be applied to an area, and/or guidelines for application, and/or guidelines for mixing the components, can also be included in the kit.

In some embodiments, the present application provides a device comprising a composition comprising a semiochemical component, a pesticide component, and one or more carriers, as described herein. In some embodiments, the device is suitable for spraying the composition.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1. Efficacy of Chlorantraniliprole+Pheromone Treatment to Control Cydia pomonella in Apple Crop

A field trial was conducted in Argentina to determine the effect of blending codling moth pheromone, (E,E)-8,10-dodecadien-1-ol, with chlorantraniliprole for control of coding moth population in apple orchards. The first flight of codling moth was targeted, at which time standard grower treatment pheromone dispensers had been placed in the respective fields. Applications of the chlorantraniliprole or chlorantraniliprole+pheromone were timed when eggs were expected to hatch.

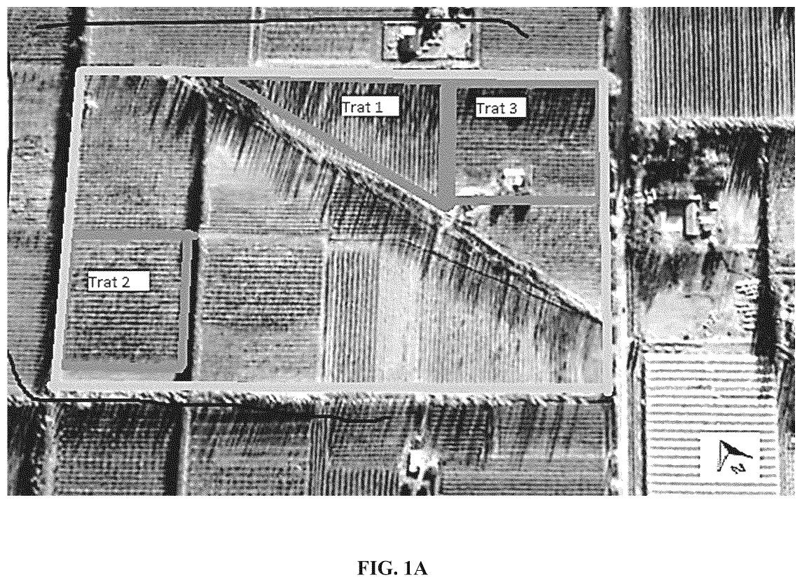

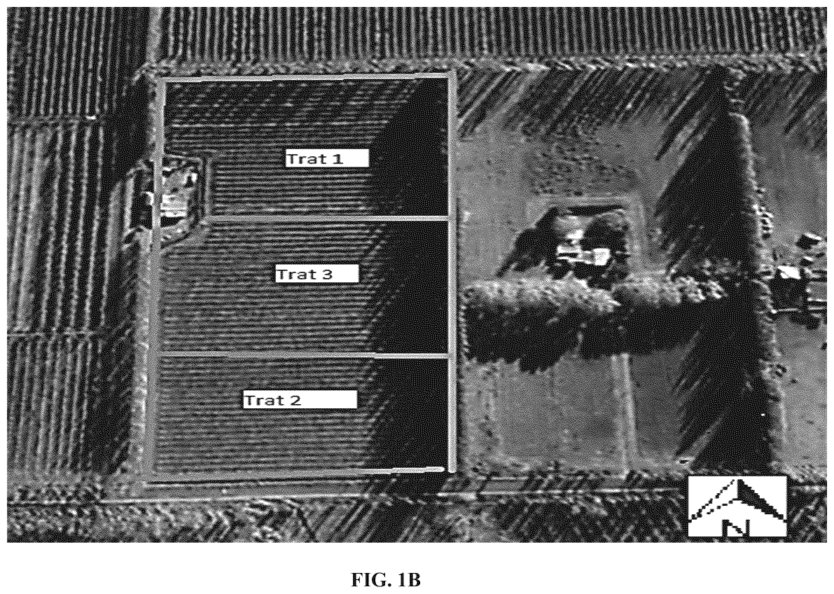

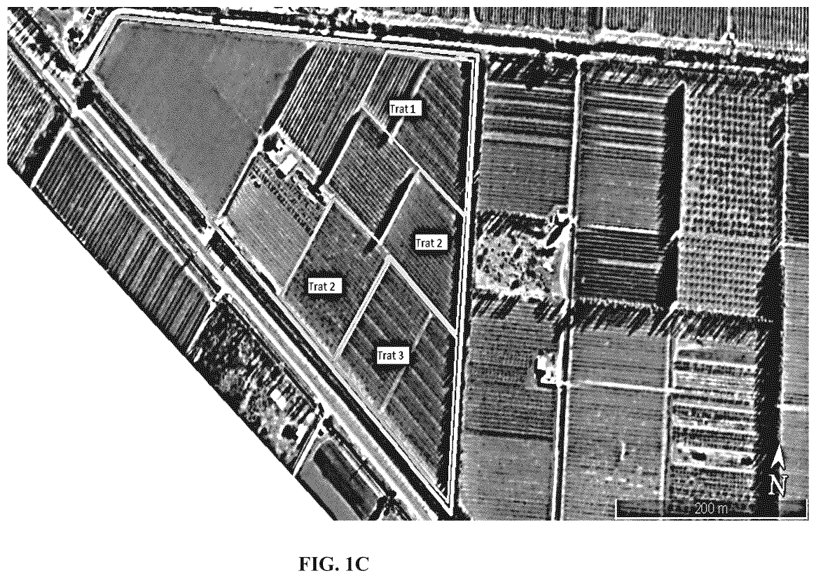

Treatment programs comprising nine tracts of land across three farms were performed (see FIGS. 1A-C). The specific trials and application timings are summarized in Table 1. SC=suspension concentrate; VP=vapor releasing product; WG=water-dispersible granules.

TABLE 1

| | | | | | | g or | g or | | |
|---|---|---|---|---|---|---|---|---|---|
| Treat | Active | g | g | | g | mL | mL | Application | |
| # | Ingredient | a.i./L | a.i./kg | Form. | a.i./hl | c.p./hl | c.p./ha | Timing | |
| 1 | Dodecadienol | 143 | — | SC | 28.6 | — | 200 | 90 | DD |
| | Rynaxypyr | 200 | — | SC | 4 | 20 | — | 250 | DD |
| | Dodecadienol | 143 | — | SC | 28.6 | — | 200 | | |
| | Rynaxypyr | 200 | — | SC | 4 | 20 | — | 250 DD + 21 days | |
| | Dodecadienol | 143 | — | SC | 28.6 | — | 200 | | |
| 2 | Rynaxypyr | 200 | — | SC | 4 | 20 | — | 250 | DD |
| | Rynaxypyr | 200 | — | SC | 4 | 20 | — | 250 DD + 21 days | |
| 3 | Cidetrak ® CM | — | 30.8 | VP | — | — | 90^{a} | 80-90 | DD |
| | Meso^{a} | | | | | | | | |
| | Acetamiprid | — | 700 | WG | 3.5 | 5 | — | 250 | DD |

| | | | | | | | |
|---|---|---|---|---|---|---|---|
| Phosmet | — | 700 | WG | 70 | 100 | — | 250 DD + 14 days |
| Phosmet | | 700 | WG | 70 | 100 | — | 250 DD + 28 days |

^{a}administered via 90 dispensers per hectare, including dispensers placed at orchard borders.

In brief, one treatment program was performed using an application of pheromone alone at 90 DD followed by applications of chlorantraniliprole plus pheromone at 250 DD and 250DD+21 days, respectively. A separate treatment was performed by applying chlorantraniliprole alone at 250 DD and 250DD+21 days. A third treatment was performed by applying the standard grower treatment of pheromone (Cidetrak® CM Meso in dispensers) at 90 DD followed by applications of acetamiprid at 250 DD and phosmet at 250 DD+14 days and 250 DD+28 days.

Treatment effects were determined by conducting fruit damage counts prior to second generation flights by evaluating 1000 fruit in each plot for codling moth damage. 100 trees were banded with 8 cm width bands of corrugated cardboard (one per trunk) in order to trap 5th instar codling moth first generation larvae as they crawl on the tree in search of a place to pupate. The bands were removed during the second week of January, taken to the lab and counted.

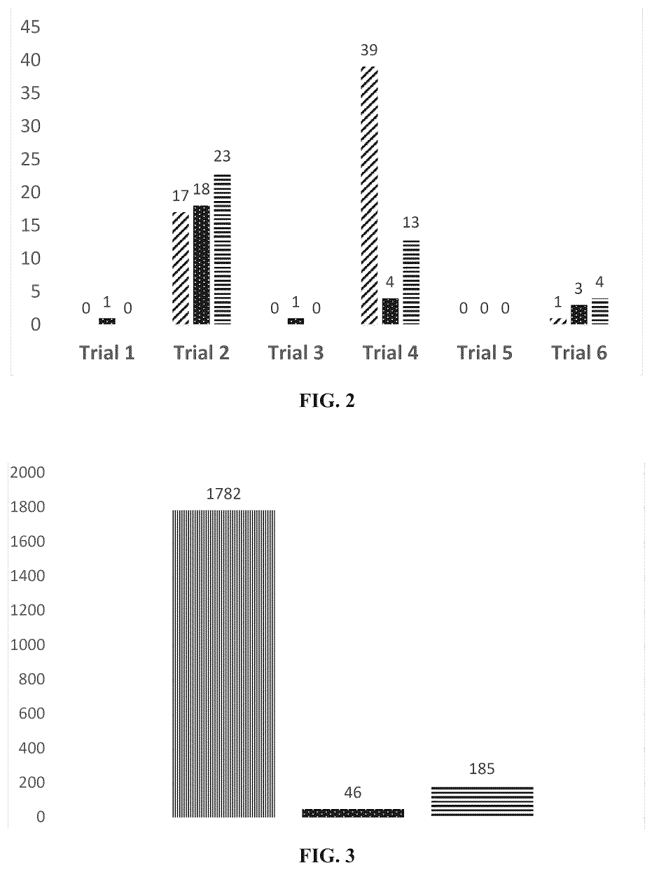

All treatments resulted in good control of codling moth damage at end of overwintering generation flight, as shown in FIG. 2. For many trials, fruit damage was too low to draw conclusions on treatment efficacy. In the trial having the highest infestation of codling moth (Trial 4 of FIG. 2), it was found that significantly less fruit was damaged in the chlorantraniliprole+pheromone plot compared to plots containing applications of chlorantraniliprole alone and pheromone+acetamiprid/imidan, as shown in Table 2 and FIG. 2. The letters in Table 2 indicate significantly different groups per Chi-square test calculation.

TABLE 2

| | Chlorantraniliprole + | Chlorantraniliprole | Pheromone + | Chi-square |
|---|---|---|---|---|
| | pheromone | Alone | acetamiprid/imidan | test |
| # Damaged Fruit/ | 4a | 39c | 13b | P < 0.001 |
| 1000 fruit | | | | |

In the trial having the highest infestation of codling moth (Trial 4 of FIG. 2), significantly fewer pupae were found in tree bands placed in the chlorantraniliprole+pheromone plot compared to plots containing applications of chlorantraniliprole alone and pheromone+acetamiprid/imidan, as shown in Table 3 and FIG. 3.

TABLE 3

| | | | Pheromone + |
|---|---|---|---|
| | Chlorantraniliprole + | Chlorantraniliprole | acetamiprid/ |
| | pheromone | Alone | imidan |
| # of Pupae | 46 | 1782 | 185 |
| Found | | | |

In summary, this study showed that addition of codling moth pheromone to chlorantraniliprole significant and unexpectedly improved control of codling moth compared to applications of (1) chlorantraniliprole alone; and (2) a combination of pheromone and acetamiprid/imidan, which is the grower standard in Argentina for apple crops.

### Example 2. Efficacy of Chlorantraniliprole+Kairomone Treatment to Control Cydia pomonella in Apple Crop

A field trial was conducted in Argentina to evaluate the efficacy of chlorantraniliprole in combination with a kairomone, ethyl (2E,4Z)-2,4-decadienoate, to improve Cydia pomonella control in foliar application of apple (Malus domestica) compared to the efficacy of chlorantraniliprole alone and kairomone alone. The treatment protocols are shown in Table 4. SC=suspension concentrate; CS=capsule suspension

TABLE 4

| Treat | Active | Conc. | | grams | mL | Application |
|---|---|---|---|---|---|---|
| # | Ingredient(s) | g a.i./L | Form. | a.i./hl | c.p./hl | Timing |
| 1 | Chlorantraniliprole | 600 | SC | 4.2 | 7 | 250 DD |
| | ethyl (2E,4Z)-2,4- | 50 | CS | 0.05 | 1 | |
| | decadienoate | | | | | |
| | Chlorantraniliprole | 600 | SC | 4.2 | 7 | 250 DD + 21 days |
| | ethyl (2E,4Z)-2,4- | 50 | CS | 0.05 | 1 | |
| | decadienoate | | | | | |
| 2 | Chlorantraniliprole | 600 | SC | 3 | 5 | 250 DD |
| | ethyl (2E,4Z)-2,4- | 50 | CS | 0.05 | 1 | |
| | decadienoate | | | | | |
| | Chlorantraniliprole | 600 | SC | 3 | 5 | 250 DD + 21 days |
| | ethyl (2E,4Z)-2,4- | 50 | CS | 0.05 | 1 | |
| | decadienoate | | | | | |
| 3 | Chlorantraniliprole | 600 | SC | 4.2 | 7 | 250 DD |
| | Chlorantraniliprole | 600 | SC | 4.2 | 7 | 250 DD + 21 days |
| 4 | Chlorantraniliprole | 600 | SC | 3 | 5 | 250 DD |
| | Chlorantraniliprole | 600 | SC | 3 | 5 | 250 DD + 21 days |
| 5 | ethyl (2E,4Z)-2,4- | 50 | SC | 0.05 | 1 | 250 DD |
| | decadienoate | | | | | |
| | ethyl (2E,4Z)-2,4- | 50 | SC | 0.05 | 1 | 250 DD + 21 days |
| | decadienoate | | | | | |

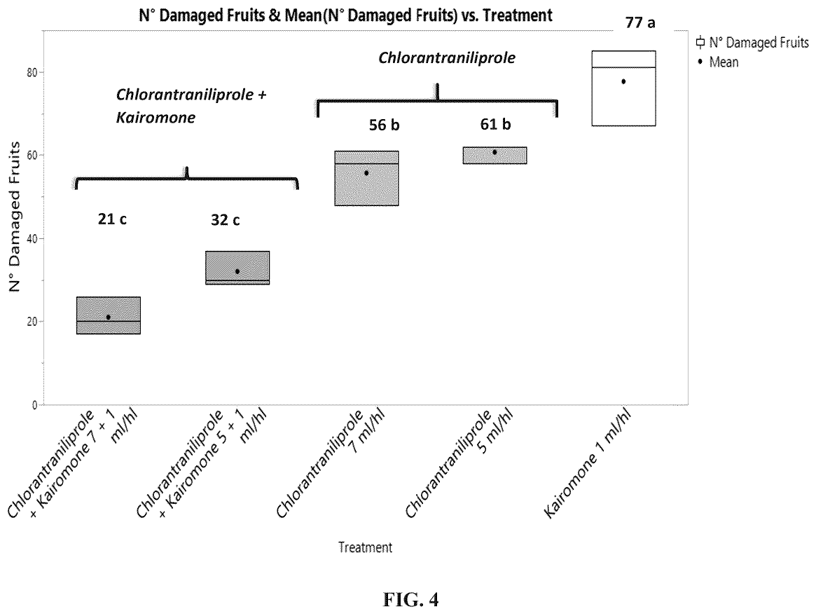

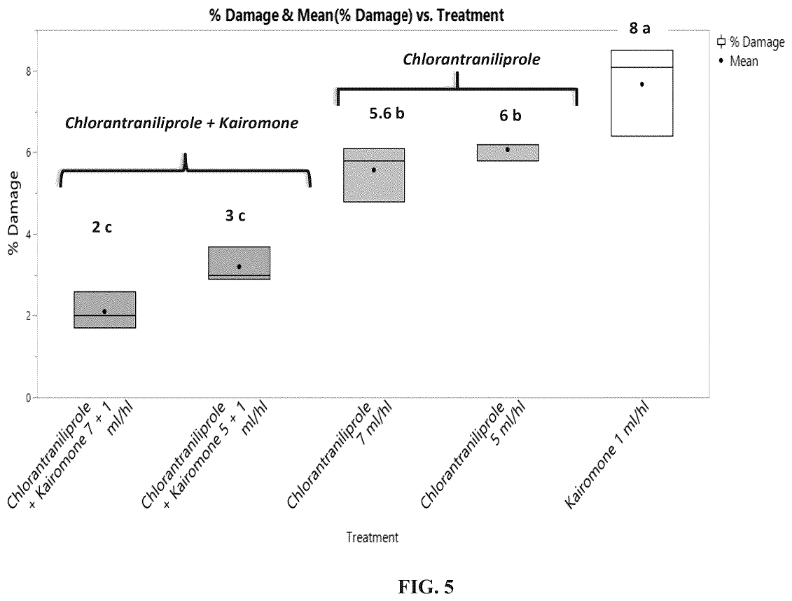

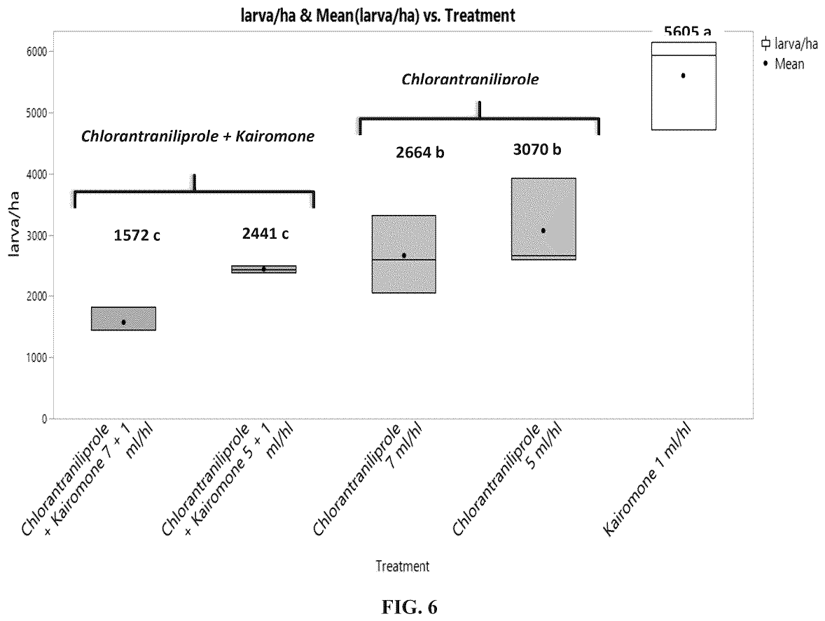

Efficacy of the trial was evaluated by (1) comparing the number of damaged fruit across the treatment groups; and (2) comparing the larva captured per hectare that were captured from corrugated cardboard traps settled in 100 trees. As shown in FIGS. 4-5, there was a significant difference in damaged fruits treatments that included chlorantraniliprole+kairomone compared to fruits treated with only chlorantraniliprole. Kairomone applied without insecticides showed a number of damaged fruits significantly higher compared to all other treatments. As shown in FIG. 6, there was a significant difference in observed larvae per hectare among treatments of chlorantraniliprole+kairomone (7 mL c.p./hl+1 mL c.p./hl) compared to treatments of only chlorantraniliprole. Kairomone applied without insecticides showed a larva per hectare significantly higher compared to all other treatments.

In summary, this field trial showed that all doses of chlorantraniliprole+kairomone were effective to reduce Cydia damage on fruits and all doses of chlorantraniliprole+kairomone were effective in the reduction of Cydia pomonella population based on the number of larva captured in corrugated cardboard traps. In addition, all doses of chlorantraniliprole+kairomone showed better performance than just applying chlorantraniliprole in reducing fruit damage, and chlorantraniliprole+kairomone (7 mL c.p./hl+1 mL c.p./hl) showed significantly better reduction in the number of captured larva compared to chlorantraniliprole treatment applied with no kairomone.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

What is claimed is:

1. A composition comprising a semiochemical component, selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemical components, chlorantranilprole, and one or more carriers.

2. The composition of claim 1, wherein the semiochemical component comprises one or more agents suitable for attracting a species of lepidoptera.

3. The composition of claim 2, wherein the species of lepidoptera is selected from Alabama argillacea, Anticarsia gemmatalis, Archips argyrospila, A. rosana, Chilo suppressalis, Chrysodeixis inludens, Cnaphalocrosis medinalis Guenèe, Crambus caliginosellus, Crambus teterrellus, Cydia pomonella, Diatraea saccharalis, Earias insulana, Earias vittella, Eupecilia ambiguella, Helicoverpa armigera, Helicoverpa zea Boddie, Heliothis virescens, Herpetogramma licarsisalis, Lobesia botrana, Ostrinia nubilalis, Pectinophora gossypiella, Phyllocnistis citrella, Pieris brassicae Linnaeus, Pieris rapae, Plutella xylostella, Scirpophaga incertulas, Sesamia inferens, Spodoptera cosmioides, Spodoptera eridania, Spodoptera exigua, Spodoptera littoralis, Spodoptera litura, Spodoptera frugiperda, Trichoplusia ni, and Tuta absoluta.

4. The composition of any one of claims 1 to 3, wherein the semiochemical component comprises one or more agents suitable for attracting Cydia pomonella.

5. The composition of any one of claims 1 to 4, wherein the composition comprises about 20% by weight to about 60% by weight of the semiochemical component compared to the total amount of the semiochemical component and chlorantraniliprole in the composition.

6. The composition of any one of claims 1-4, wherein the composition comprises about 35% by weight to about 45% by weight of the semiochemical component compared to the total amount of semiochemical component and chlorantraniliprole component in the composition.

7. The composition of any one of claims 1-4, wherein the composition comprises about 1% by weight to about 15% by weight of the semiochemical component compared to the total amount of the semiochemical component and chlorantraniliprole in the composition.

8. The composition of any one of claims 1-4, wherein the composition comprises about 1% by weight to about 10% by weight of the semiochemical component compared to the total amount of the semiochemical component and chlorantraniliprole in the composition.

9. The composition of any one of claims 1-8, wherein the composition comprises about 40% by weight to about 80% by weight of chlorantraniliprole compared to the total amount of the semiochemicals component and chlorantraniliprole in the composition.

10. The composition of any one of claims 1-8, wherein the composition comprises about 20% by weight to about 60% by weight of the semiochemical component and about 40% by weight to about 80% by weight of chlorantraniliprole compared to the total amount of the semiochemcial component and chlorantraniliprole in the composition.

11. The composition of any one of claims 1 to 10, wherein the semiochemical component is (E,E)-8,10-dodecadien-1-ol.

12. The composition of any one of claims 1 to 10, wherein the semiochemical component is ethyl (2E,4Z)-2,4-decadienoate.

13. The composition of any one of claims 1-12, wherein the composition further comprises a carrier.

14. The composition of any one of claims 1 to 13, wherein chlorantraniliprole is suitable for controlling a population of Cydia pomonella.

15. A process of preparing the composition of any one of claims 1 to 14, comprising admixing a first composition comprising the semiochemical component and one or more carriers, and a second composition comprising chlorantraniliprole and one or more carriers, thereby preparing the composition.

16. The process of claim 15, wherein the first composition comprises about 1 w/v % to about 20 w/v % of the semiochemical component, selected from (E,E)-8,10-dodecadien-1-ol, (E,E)-8,10-dodecadienyl acetate, (E,E)-8,10-dodecadienal, and ethyl (2E,4Z)-2,4-decadienoate, or any combination of the forgoing semiochemicals components.

17. The process of claim 15 or 16, wherein the second composition comprises about 15 w/v % to about 25 w/v % of chlorantraniliprole

18. The process of any one of claims 15 to 17, wherein the semiochemical component is (E,E)-8,10-dodecadien-1-ol.

19. The process of any one of claims 15 to 17, wherein the semiochemical component is ethyl (2E,4Z)-2,4-decadienoate.

20. A method of controlling a population of Cydia pomonella, comprising applying the composition of any one of claims 1 to 14 to an area in an amount effective to attract the Cydia pomonella, wherein the area has been identified as being populated or having been populated with the Cydia pomonella.
